(19) United States
(12) Patent Application Publication
(10) Pub. No.: US 2011/0047272 A1
(43) Pub. Date: Feb. 24, 2011

(54) Dissemination of Network Management Tasks in a Distributed Communication Network

(76) Inventors: Anne-Marie Bosneag, Athlone (RO); David Cleary, Athlone (IE)

Correspondence Address: POTOMAC PATENT GROUP PLLC, P. O. BOX 270, FREDERICKSBURG, VA, 22404, US

(21) Appl. No.: 12/528,446

(22) PCT Filed: Feb. 28, 2008
(86) PCT No.: PCT/EP2008/052418

§ 371 Date: Nov. 8, 2010

Related U.S. Application Data
(60) Provisional application No. 60/894,085, filed on Mar. 9, 2007.

(51) Int. Cl. G06F 15/173

(52) U.S. Cl. 709/226

(57) ABSTRACT

A system, method, and network node (14) for distributing a network management task from a source to a plurality of network nodes in a traffic network (10). When a task is received in a network node (14), the node determines whether the task is to be forwarded to other network nodes. If so, the receiving network node utilizes application-level knowledge of the functionality of each neighboring node to select one or more neighboring nodes that need to receive the task. The receiving network node then utilizes a functional management overlay layer (12) known as the Data Discovery and Distribution, D³, layer to communicate the task to the selected neighboring nodes. The network node receives responses from the neighboring nodes, aggregates the responses with local information, and sends an aggregated response to the source.

### RELATED APPLICATIONS

This application claims the benefit of U.S. Provisional Application No. 60/894,085 filed Mar. 9, 2007.

### TECHNICAL FIELD OF THE INVENTION

This invention relates to network management activities in communication networks. More particularly, and not by way of limitation, the invention is directed to a system and method for disseminating network management tasks to network nodes in large, complex, and dynamic communication networks, and solving the tasks in a distributed manner.

### DESCRIPTION OF RELATED ART

The management architecture in use today in communication networks is based on an architecture specified by the ITU-M series of standards. This seminal work in the field of network management had at its center the simple client-server architecture. In the standard text, this is referred to as the “agent-manager” relationship, where the Agent resides on the network equipment being managed and the Manager is a central entity that interacts with the agent for the retrieval of management information and coordination of configuration tasks. This is basically the same paradigm that current third generation (3G) Network Management System (NMS) solutions are based on. This architecture relies on a centralized element or server responsible for collecting data from managed devices, aggregating the data, and setting the state information on the device. The functionality realized in this server is typically divided according to the FCAPS functional taxonomy, as defined by ITU-T in the X.700 specification family.

Communication networks continue to grow in size and complexity, which leads to increased dynamics as individual nodes go on and off line, and links fail and are repaired. These factors introduce a number of challenges to the current centralized NMS architecture. To meet these challenges in part, network management tasks are being distributed down into the network nodes and other network entities themselves in an attempt to increase the availability, performance characteristics, scalability, and correctness guarantees of the network management system.

The ability to find information without a central look up table is a difficult task. One technology which enables node and data discovery in a distributed fashion is the Distributed Hash Table (DHT). DHTs (such as Chord, Pastry, Tapestry, CAN, Bamboo, Kademlia, Coral, and Viceroy) are structured peer-to-peer systems in which all nodes participate equally in consuming/providing data and solving distributed tasks. DHTs are built as logical overlays on top of the physical network, and provide a routing mechanism that relies on a very precise naming scheme. The result is a fully distributed system which offers many advantages, such as scalability to millions of peer nodes, efficient lookup algorithms, robustness and automatic reconfiguration in the face of node arrival/departure and ease of management and deployment.

In essence, all DHTs offer the same functionality (i.e., location of peers/data), with some variations in terms of properties, such as the number of routing neighbors, choice of iterative vs. recursive lookups, choice of routing table creation algorithms, and neighbor selection strategies. Moreover, over time, different DHTs have evolved in the same strategic direction, implementing the best choices as they emerged from studies on existing DHTs. To this end, most current DHTs guarantee that any node can be discovered in an average number of overlay hops of O(log N), with local information stored at each node of O(log N), where N is the number of nodes in the network, thus guaranteeing the scalability of the solution.

DHTs, however, have several disadvantages as well. The disadvantages of DHTs reside primarily in the fact that the mapping between the physical network nodes and the overlay is usually independent of any functionality of the nodes being mapped. Therefore, inefficiencies arise when management tasks are distributed.

In the context of distributed network management tasks, at the application level, it is normally necessary that each network node be able to identify a certain number of “neighbors” that it will be in contact with for completing its part of the assigned task(s). This set of neighbors is dependent on the task to be solved. For example, if the task is to verify the consistency of intra-RNC neighbor-cell relations in a WCDMA-based radio network, each Radio Network Controller (RNC) must initiate contact with the other RNC's that its cells have neighboring relations with, and must request the other RNCs to determine whether the cell neighboring relations are defined symmetrically on the neighbor's side.

In general, data existing in the managed network (for example relations between network nodes), usually define a directed graph that can be used at the application level for propagating the processing request from one network element to another until all nodes that should partake in the distributed task are contacted. If this graph is strongly connected (i.e., there is a path between any two nodes in the graph), then requests originating at any network node will eventually be propagated to all other network nodes (presupposing some underlying layer which enables node discovery and addressing).

In current centralized NM systems, the central managing node's view of the network is used when processing management tasks. In the context of networks of increased size, complexity, and dynamics, the use of central knowledge for deciding whether a request for distributed processing of a network management task has reached all nodes does not provide high guarantees in terms of scalability, performance, availability, and consistency.

Regarding scalability, current solutions have problems handling increases in the number of nodes being managed. The process of data collection, aggregation, and correlation becomes very complex as there is a commensurate increase in the volume of data to be managed relative to the number of devices/network elements which are to be managed. Regarding performance and availability, the 1−n (one manager to many agents) relationship in current solutions creates problems in case of failure of the manager. Similarly, the central node can be overloaded collecting data from the nodes and processing the collected data. In more extreme cases, when a management task is related to an entire network, such as determining whether a property holds true across all nodes in the network where there is shared state information (cell parameters), this workload can be difficult to handle in an efficient manner at one central location.

Finally, current solutions have problems maintaining consistency of data collected by the central management node. When working on a snapshot or copy of information retrieved from the network to support cell planning, for example, the central node performs all data processing on local copies of the actual data. Ensuring strict consistency between the data on the managed node and the data on the OSS node is extremely difficult or impossible in massively distributed systems.

The above issues raise serious and complicated challenges as networks evolve and the volume of entities to be managed grows ever larger. What is needed in the art is more viable network management architecture and method that helps alleviate the problems associated with the issues outlined above. Such an architecture should enable efficient distribution of network management tasks to nodes throughout the network, and should readily accommodate changes in the architecture graph. The present invention provides such an architecture and method.

### SUMMARY OF THE INVENTION

The present invention enables direct communication between nodes in a telecommunications or similar network, making possible the distribution of network management tasks within the managed network itself. The invention overcomes the disadvantages of the prior art by utilizing semantic information from the traffic network to build a Data Distribution and Discovery (D³) layer, efficiently dealing with dynamic situations and maintaining several overlays for the different management tasks. The invention thus utilizes functional information when constructing the mapping (in the information hashed for constructing the overlay identity), and constructs a 1-to-n mapping to accommodate different network management functionalities. Network nodes may collaborate in response to network management requests thus balancing the network management load among the nodes in the network, increasing the scalability of the network management solution, and/or using the actual data on the nodes as opposed to cached, possibly outdated copies on a central node, as is traditionally the case in current network management approaches.

In one aspect, the present invention is directed to a method of distributing a network management task from a source to a plurality of network nodes in a traffic network having an application layer and a functional management overlay layer. The method includes the steps of receiving the network management task in a network node; utilizing application-layer information regarding the functionality of neighboring nodes to select by the receiving network node, at least one neighboring node that needs to receive the network management task; and utilizing a functional management overlay layer to distribute the network management task from the receiving network node to the at least one selected neighboring node. The receiving network node then receives responses from the neighboring nodes, aggregates the responses, and sends an aggregated response to the source.

In another aspect, the present invention is directed to a system for distributing a network management task from a source to a plurality of network nodes in a traffic network. The system includes means within each network node for selecting at least one neighboring node to receive the network management task. The network node utilizes application-layer knowledge of the functionality of each neighboring node to select only neighboring nodes that need to receive the network management task. The system also includes a functional management overlay layer for directly communicating between each network node and the node's neighboring nodes; and means within each network node for utilizing the functional management overlay layer to distribute the network management task from the network node to the at least one selected neighboring node. The network node then receives responses from the neighboring nodes, aggregates the responses, and sends an aggregated response to the source.

In another aspect, the present invention is directed to a network node for distributing a network management task to a plurality of neighboring nodes in a traffic network. The network node includes means for selecting at least one neighboring node to receive the network management task, wherein the network node utilizes application-layer knowledge of the functionality of each neighboring node to select only neighboring nodes that need to receive the network management task; and means for distributing the task to the at least one selected neighboring node utilizing a functional management overlay layer that provides direct communication between each network node and the node's neighboring nodes.

In another aspect, the present invention is directed to a network node for collecting network management information from a plurality of neighboring nodes in a traffic network in response to a network management request received from an originating node. The network node includes means for determining local management information needed to respond to the request and requesting remote information; means for utilizing application-layer knowledge of the functionality of each neighboring node to identify neighboring nodes where the remote management information is located; and means for utilizing a functional management overlay layer to send request messages to the identified neighboring nodes to request the remote management information. The network node also includes means for receiving the requested remote management information in response messages from the identified neighboring nodes; and means for aggregating the remote management information and the local management information and sending the aggregated information to the originating node.

### BRIEF DESCRIPTION OF THE DRAWINGS

In the following, the essential features of the invention will be described in detail by showing preferred embodiments, with reference to the attached figures in which:

FIG. 1 is a simplified block diagram of a network architecture suitable for implementing the present invention;

FIG. 2 is a simplified block diagram of a network node in an exemplary embodiment of the present invention;

FIG. 3 is a flow chart of the application-layer steps of an exemplary embodiment of the method of the present invention; and

FIG. 4 is a flow chart of the distribution-layer steps of an exemplary embodiment of the method of the present invention.

### DETAILED DESCRIPTION OF EMBODIMENTS

The present invention provides an architecture for distributing and solving network management tasks in a decentralized manner. The architecture of the present invention distributes management tasks based on an overlay. The roles of the overlay are: (1) to provide direct addressing between the different nodes (i.e., not through a central node), and (2) to provide an alternative way to reach nodes beyond relations defined at the application level. In this manner, the invention provides scalability, performance, availability, and consistency when deciding whether a request for distributed processing of a network management task has reached all nodes.

The architecture of the present invention allows for large growth in the number of network elements being managed. The architecture handles the increased complexity and dynamics which result from distributing the management functions between the managing systems and the managed systems by imposing a small overhead on each of the nodes. As a result, decentralizing the management tasks helps to alleviate the load on the managing system, to improve the efficiency of the management process, and to ensure that the data processing is performed on the actual data, as opposed to potentially inconsistent copies of the data.

In order to enable the distribution of network management tasks, the architecture of the present invention allows for communication of management tasks and requests, not only between the managing system and managed system(s), but also between the managed system(s), when it is more appropriate to do so. This new architectural approach demands that managed systems must be able to locate and communicate with each other without necessarily using a centralized system as an intermediary.

For reliability reasons, automated routing around failures and automatic reconfiguration in the face of node arrival/departure is extremely important in the context of networks spanning many thousands or even tens of thousands of managed systems. As noted, to enable distribution of network management tasks, managed systems must be able to locate and address each other without the use of centralized knowledge. This discovery plane in turn should be scalable and reconfigurable, and logically integrated with the existing network structure, so as to be of maximum use to the management applications. In various embodiments of the present invention, the identifiers used in the discovery plane are logically related to unique semantic information currently defined and used in the managed network.

The present invention introduces a new function overlay (abstraction) layer within the traffic network referred to as the Data Distribution and Discovery (D³) layer. The D³ layer supports effective control and management of network elements (managed systems) by providing a framework and architecture that supports dynamic discovery of the relevant information needed to support managing the traffic network in a distributed manner, and provides the infrastructure needed to support distributed management algorithms which can be used for the creation of an autonomic management system. The invention uses semantic information from the traffic network and network management tasks to build the D³ layer, dynamically maintains the D³ layer when the network configuration or ^{the} semantics change, and maintains multiple overlays in the D³ layer for different network management tasks.

The D³ layer is a computational abstraction layer that sits on top of the traffic network and below the classic Network Management “Manager” layer. The D³ layer is used to enable distributed discovery and addressing of nodes, necessary to support distributing the network management tasks across the network elements. The primary objective of the D³ layer is to enable nodes to autonomously locate each other and communicate directly, without the need, support, or central knowledge of a central node to forward requests.

The methodology described herein builds on existing concepts such as peer-to-peer systems. The D³ layer is used for discovering distributed network nodes and management information, and distributing network management tasks to the nodes. These tasks require some form of peer-to-peer architecture, which allows nodes to directly communicate with each other and collaborate together, so as to accomplish specific network management tasks. In peer-to-peer systems, each node has partial knowledge of the network, being therefore able to contact a subset of nodes in the system. The present invention can also exploit this knowledge for extending requests to parts of the network that are not necessarily covered by network management relations at the application level.

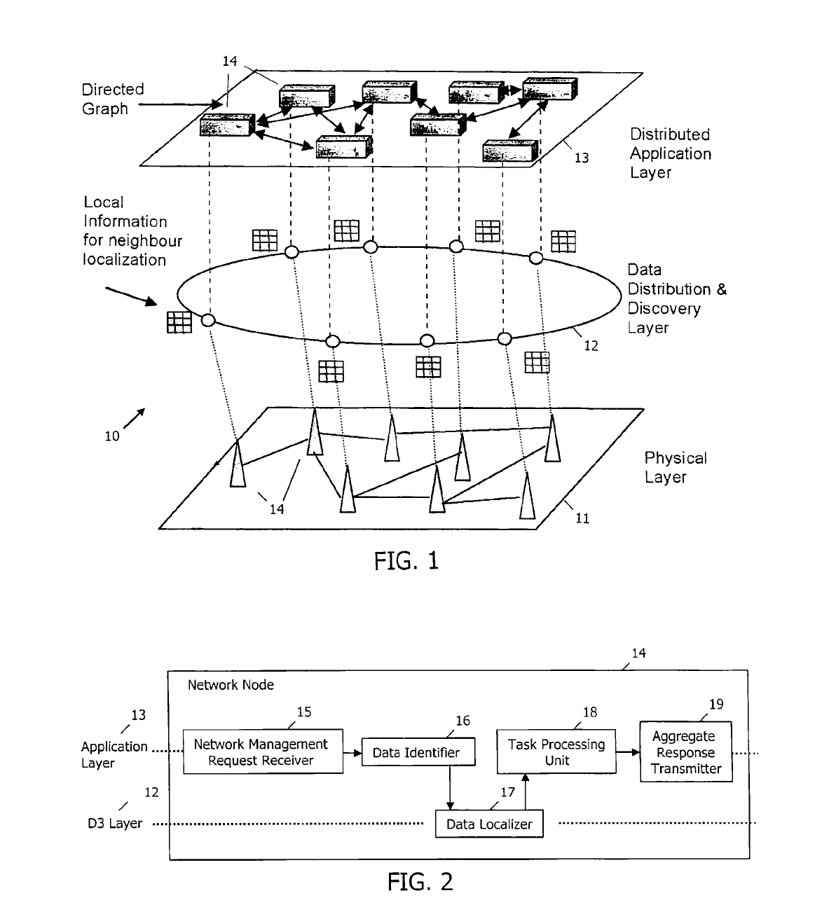

FIG. 1 is a simplified block diagram of a network architecture 10 suitable for implementing the present invention. In general, the architecture comprises three distinct layers: a physical layer 11, a Data Discovery and Distribution (D³) layer 12, and a distributed application layer 13. The physical layer 11 provides synchronous and asynchronous communication between network nodes 14. The communications may be wired or wireless, and may include any one of a number of technologies including, but not restricted to, ATM, Ethernet, TCP/IP, and the like. The D³ layer 12 supports the application layer 13 and provides an indexing capability through an automatically reconfigurable peer-to-peer node discovery layer. The D³ layer may be referred to herein as the overlay network. The application layer provides the basis on which network management tasks are built. The application layer organizes the network nodes into a directed graph based on application-level relations between the nodes. This graph, in turn, defines how the network nodes may collaborate with each other for network management task completion.

In brief, the application-level graph may be viewed as being used to propagate the request, the D³ layer as being used to locate and address nodes, and the physical layer as being used for the actual data communication.

At the D³ layer 12, routing tables and/or neighborhood sets are created according to a pre-defined algorithm, which enables distributed discovery of network nodes 14 and data associated with the network nodes. When a message needs to be sent from one network node to another, the routing information in the overlay node (i.e., local information at the D³ layer) is utilized to discover a route to the target node. The overlay routing works by matching prefixes of nodes from the routing table with the final destination node.

In one exemplary embodiment, the overlay is implemented utilizing DHT technology, or a variant thereof. Most DHT implementations will guarantee the discovery of the destination node in an average of O(log N) steps, where N is number of nodes in the D³ layer, with O(log N) information stored in the local routing tables. The performance of the discovery algorithm is related to how much information is stored in the routing tables—the more information stored, the easier it is to find the next node. Therefore, whenever if an average performance of O(log N) is desired, the routing tables must be of O(log N) size.

The design of the network architecture 10 is based on the following principles:
(1) Network element boot strapping—this is the setup of the overlay network management network. This allows for the dynamic behavior of the overlay (D³) layer and thus facilitates the formation of the overlay network. The architecture utilizes an inventive process and mechanism for passing data between the traffic network and the overlay. As the node attaches to the managed network, semantically specified information or domain-specific encoding of index space is transferred (e.g., Fully Distinguished Name (FDN) of a Radio Network Controller (RNC) in a WCDMA Radio Access Network (WRAN)). This information enables application-level routing of network management requests.
(2) Overlay network stability—this involves observing the overlay network, reconfiguring the local information at the D³ layer, and responding to requests from neighbors as the traffic network changes. This aspect refers to the need for reconfiguration of the routing tables over time to handle changes in the physical network—these routing tables contain a distributed index of management data and management tasks or functions. As network elements leave the traffic network (either as a planned activity or due to a fault or failure) and consequently leave the application network, the routing tables in the overlay layer must be reconfigured to account for the changes. Additionally, as the state or description of the management function changes, a new node is added to the overlay which encodes the new description of the management function semantics.
(3) Support the construction of a 1-to-N mapping of traffic nodes to the overlay network—this involves creating network management specific routing. This ensures that the semantic mappings are preserved even if the traffic node is present in multiple overlay networks. This enables multiple overlays to be maintained on a single traffic network if that is beneficial or necessary.
(4) Support for data aggregation in the graphs formed by application logic traversal of the overlay network and in the graphs formed by nodes sharing common prefixes in their identifiers in the D³ layer. The second variant is essentially a management function of the overlay layer itself, which can be exploited to stop or limit the number of data transfer messages.
(5) Message communication—this allows for information to be transferred between distributed entities. The following is an example of the information which may be contained in a message:
   (a) The Message type—utilized to differentiate between the different types of messages being forwarded through the system;
   (b) The Address of the Originator of the message—this is specified as the overlay identity of the originating node;
   (c) A Sequence Number—utilized for filtering duplicate messages;
   (d) A Semantic Encoded Hash—this is the target identity used for discovery of the destination node for the message, through a lookup of the distributed index;
   (e) The Payload encoding—type of encoding for the payload; and
   (f) The actual Payload—this is application-specific information.

When a distributed network management function needs to initiate communication between network nodes, the following sequence of activities may be performed:
(1) For each distributed network management task request, the sequence of actions completed at each network node at the application level is:
   (a) Based on the type of request, identify the local and remote data needed to complete the task;
   (b) Identify the network nodes where the needed remote data is located, or may be located, and create the required request message(s) for the remote network nodes;
   (c) Send the necessary messages to the D³ distribution layer for delivery to the remote network nodes; and
   (d) Create a response message. Each network node waits to receive response messages from each of the other network nodes to which it forwarded the task request. The network node then aggregates the responses into an aggregated response message, which it sends to the source from which it received the task request. It may be necessary to wait for some period of time to receive the data from the remote network nodes and then reply with the request result to the request originator.
(2) At the distribution layer, whenever a message is received, if the destination is the current receiving node, then the message is forwarded onto the application level. If not, the routing tables/neighborhood sets are used to determine to which network node the message should be forwarded.

FIG. 2 is a simplified block diagram of a network node 14 in an exemplary embodiment of the present invention. A network management request receiver 15 receives a request from a source or initiating node at the application layer 13. A data identifier 16 analyzes the request and identifies the data needed to perform the task. The node passes this information to a data localizer 17 at the D³ layer. The data localizer finds disconnected network components using the D³ layer, and localizes (i.e., finds) the data needed. The data localizer then sends the data to a task processing unit 18 at the application layer. An aggregate response transmitter 19 collects responses from downstream nodes and sends an aggregate response to the source or initiating node.

The following is an example illustrating the architectural approach outlined above, as applied to a UMTS or LTE radio network, using a Distributed Hash Table (DHT) as the underlying solution for communication and discovery. The D³ distribution overlay built on top of the physical network uses a DHT to enable the network nodes to discover each other in a distributed fashion. Each node keeps a partial view of the network and supports a deterministic method for forwarding requests from any node in the distribution overlay to any other node. The example presented here uses the Bamboo algorithm, although any similar implementation would also provide the same basic level of support. In the Bamboo based solution, each node keeps:
(1) a routing table, which contains the identities and IP-addresses of network nodes whose identities share common prefixes with the current node. This is the most important information used in addressing other nodes, because the routing protocol works by matching prefixes of increasing length until the best match to the target node identity is found in the network.
(2) a leafset, which contains L neighbors in the overlay ring, where L is a parameter of the DHT's architecture (|L|/2 nodes with identities larger than the identity of the current node and |L|/2 nodes with identities smaller than the identity of the current node). There is a tradeoff between the size of the leafset, L, i.e. the number of nodes that can be reached in one overlay hop from the current node, and the amount of local information a node has to store. In a normal implementation, L is set to the value 16 or 32.
(3) a neighborhood set, which contains the known neighbors in the physical network, i.e. network nodes that are close to the current network node based on a metric defined in the physical layer (for example, geographical distance, latency of links, or combinations thereof). This set of network nodes is used when populating routing tables and leafsets, to ensure that if multiple choices exist, the network node closest to the current network node with respect to the pre-defined metric is chosen. The set of network nodes is also used to route around potential partitions in the overlay (i.e., if failures result in the creation of partitions in the overlay, information about neighbors in the physical network is used to reach other partitions).

The routing table, leafset, and neighborhood set are automatically created and/or updated as a node joins the network, and are also automatically reconfigured when nodes leave the network.

Each of the following steps corresponds to the architectural principle outlined in the previous section.
(1) Network element boot-strapping: This is achieved via element management logic residing on each network node. The semantic encoding of the management function is archived by mapping the Fully Distinguished Name (FDN) of the “Managed Element” into the Bamboo hash, using the SHA-1 algorithm, which produces a 160-bit identity unique in the overlay name space. This encoding enables the distributed management data/function to be accessed by other nodes through the distributed index. The node then updates its own routing tables as well as its leafset and neighborhood list, and propagates this action to its neighbors.
(2) Overlay network stability: As the overlay network is formed, the functionality residing on the network node performs the following algorithmic task.
   (a) When a new node appears in the traffic network, boot-strapping occurs.
   (b) When a node disappears, the event it is detected as either the result of an unsuccessful routing or because a heartbeat message sent between neighboring nodes is missed. This indication of a node having left the overlay triggers a routing table reconfiguration. This is achieved by asking neighboring nodes for a replacement entry. If none is found, a blank entry is entered into the routing table. Note that routing still works, in spite of some blank entries in the distributed index, because alternative routes will be found.
   (c) When an old network node on the overlay must be replaced, the old node is removed and the same operation as outlined in the previous step is triggered. Then the new node is added into the distributed index, using the bootstrap procedure. On successfully completing this task, a new entry which encodes the new semantic is inserted into the DHT.
(3) Construction of a 1−n mapping of traffic nodes to overlay network nodes: The initial routing of messages is achieved from the DHT information received from the retrieval for the lookup; the message is then routed to the node in question. There, the communication support terminating the message on the traffic node de-marshals the message, examines the semantic hash, and routes the message to the correct process (i.e., the one that implements the logic corresponding to the semantic hash).
   (4) Support for data aggregation in the graphs formed by application logic traversing the overlay network or in the graphs formed by nodes sharing common prefixes in the encoding: It is a Bamboo characteristic that requests to nodes sharing common prefixes in their IDs will be routed along common routes, thus forming trees within the overlay. This feature is essentially a management function of the overlay to stop/limit the number of messages or data transferred.
(5) Messaging: For this specific example, the message format is of the following type:

<type><seq_no><target><type of encoding><application-specific payload>

However, many types of message formats and content may be envisaged within the scope of the present invention.

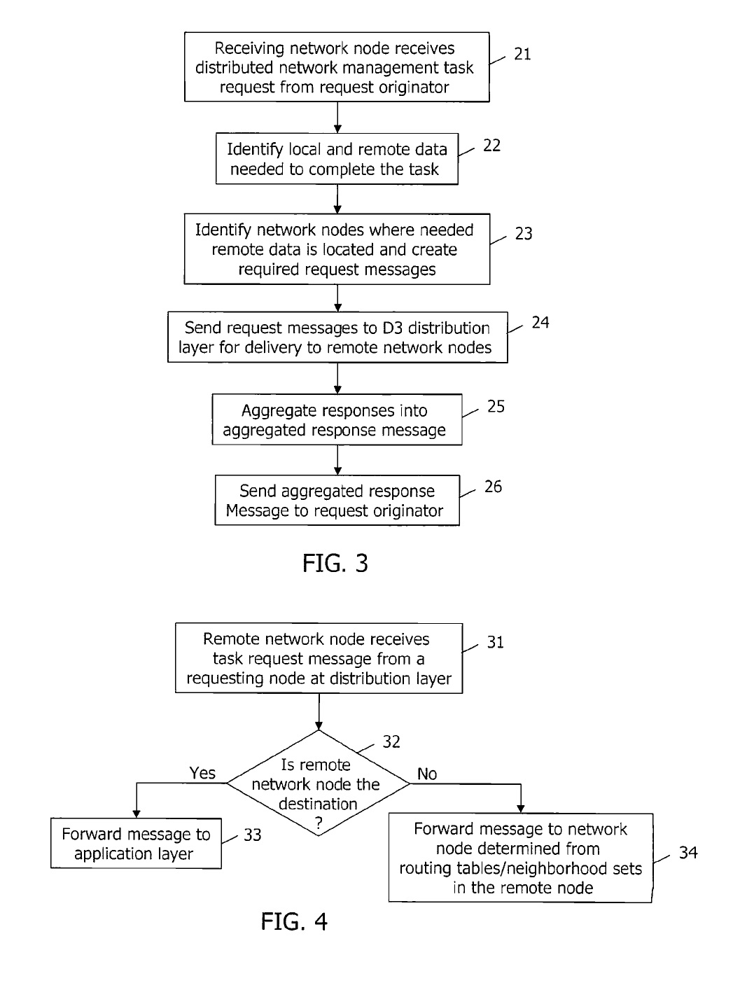

FIG. 3 is a flow chart of the application-layer steps of an exemplary embodiment of the method of the present invention. The method is performed when a distributed network management function needs to initiate communication between network nodes. At step 21, a distributed network management task request is received in a receiving network node from a request originator. At step 22, the receiving node identifies the local and remote data needed to complete the task based on the type of task request. At step 23, the receiving node identifies the network nodes where the needed remote data is located, or may be located, and creates the required request message(s) for the remote network nodes. At step 24, the receiving node sends the necessary messages to the D³ distribution layer for delivery to the remote network nodes. At step 25, after responses are received from the remote network nodes, the receiving node creates an aggregated response message. Each network node waits to receive response messages from each of the other network nodes to which it forwarded the task request. The network node then aggregates the responses into an aggregated response message. At step 26, the aggregated response message is sent to the request originator. It may be necessary to wait for some period of time to receive the data from the remote network nodes and then reply with the aggregated result to the request originator.

FIG. 4 is a flow chart of the distribution-layer steps of an exemplary embodiment of the method of the present invention. At step 31, a task request message from a requesting node is received at the distribution layer in a remote network node. The request message may be received from a requesting node such as the receiving node discussed in FIG. 3. At step 32, it is determined whether the remote network node is the destination for the request message. If so, the method moves to step 33 where the message is forwarded to the application layer for processing. If not, the method moves to step 34 where the remote node utilizes its routing tables/neighborhood sets to determine to which network node the message should be forwarded, and forwards the message.

It should also be understood from the above description that the roles of originating and receiving nodes can co-exist in the same node. Thus, the requesting node and the remote network node may be physically co-located in the same node.

The present invention may of course, be carried out in other specific ways than those herein set forth without departing from the essential characteristics of the invention. The present embodiments are, therefore, to be considered in all respects as illustrative and not restrictive and all changes coming within the meaning and equivalency range of the appended claims are intended to be embraced therein.

1. A method of distributing a network management task from a source to a plurality of network nodes in a traffic network having an application layer and a functional management overlay layer, said method comprising the steps of:
receiving the network management task in a network node;
performing in the receiving node, any local task required by the network management task;
if the receiving node has at least one neighboring node, utilizing application-layer information regarding the functionality of neighboring nodes to determine by the receiving network node, whether any neighboring nodes need to receive the network management task; and
upon determining that at least one neighboring node needs to receive the network management task, utilizing the functional management overlay layer to distribute the network management task from the receiving network node to the at least one neighboring node.

2. The method as recited in claim 1, wherein the network node distributes the network management task to a plurality of neighboring nodes, and the method further comprises the steps of:
receiving in the network node, a plurality of responses from the plurality of neighboring network nodes;
aggregating the plurality of responses into an aggregated response; and
sending the aggregated response to the source.

3. The method as recited in claim 1, further comprising storing in a table at the functional management overlay layer in each network node, network management information for a plurality of neighboring nodes, said information enabling the network nodes to route network management tasks to neighboring nodes.

4. The method as recited in claim 3, further comprising updating the network management information stored in each node at the functional management overlay layer whenever configuration changes occur in the traffic network.

5. The method as recited in claim 3, further comprising providing multiple overlay layers by providing a mapping from each network node to multiple information tables at the functional management overlay layer.

6. The method as recited in claim 1, further comprising:
determining by a neighboring node that receives the network management task, whether the task is to be processed by the neighboring node; and
if the task is to be processed by the neighboring node, sending the task to the neighboring node's application layer for processing.

7. A system for distributing a network management task from a source to a plurality of network nodes in a traffic network, said system comprising:
means within each network node that receives the network management task for performing any local task required by the network management task;
means within each receiving node for utilizing application-layer information regarding the functionality of neighboring nodes to determine by the receiving node, whether any neighboring nodes, if the receiving node has at least one neighboring node, need to receive the network management task;
a functional management overlay layer for directly communicating between each network node and the node's neighboring nodes; and
means within each receiving node for utilizing the functional management overlay layer to distribute the network management task from the receiving node to any neighboring nodes that need to receive the network management task.

8. The system as recited in claim 7, wherein the receiving network node distributes the network management task to a plurality of neighboring nodes, and the system further comprises:
means for receiving in the receiving network node, a plurality of response messages from the plurality of selected neighboring nodes;
means for aggregating the plurality of response messages into an aggregated response message; and
means for sending the aggregated response message to the source.

9. The system as recited in claim 7, wherein the overlay network layer is implemented utilizing a Distributed Hash Table (DHT), and wherein the means for utilizing application-layer information to determine whether any neighboring nodes need to receive the network management task includes means for selecting at least one neighboring node to forward the network management task, wherein the selected neighboring node is one step closer to a final recipient.

10. The system as recited in claim 7, further comprising:
means within a neighboring node that receives the network management task for determining whether the task is to be processed by the neighboring node; and
means responsive to a determination that the task is to be processed by the neighboring node for sending the task to the neighboring node's application layer for processing.

11. The system as recited in claim 7, wherein the receiving node and at least one neighboring node are co-located in a single physical node.

12. A network node for distributing a network management task to a plurality of neighboring nodes in a traffic network, said network node comprising:
means for selecting at least one neighboring node, if the network node has any neighboring nodes, to receive the network management task, wherein the network node utilizes application-layer knowledge of the functionality of each neighboring node to select only neighboring nodes that need to receive the network management task; and
means for distributing the task to the at least one selected neighboring node utilizing a functional management overlay layer that provides node-to-node communication between each network node and the node's neighboring nodes, without using a central node for discovery and forwarding the task.

13. The network node as recited in claim 12, wherein the functional management overlay layer is implemented utilizing a Distributed Hash Table (DHT), and wherein the means for selecting at least one neighboring node includes means for selecting at least one neighboring node to forward the network management task, wherein the selected neighboring node is one step closer to a final recipient.

14. The network node as recited in claim 12, wherein the network node communicates the network management task to a plurality of selected neighboring nodes, and the network node further comprises:
means for receiving a plurality of response messages from the plurality of selected neighboring nodes; and
means for aggregating the plurality of response messages into an aggregated response message.

15. The network node as recited in claim 12, wherein the network node and at least one neighboring node are co-located in a single physical node.

16. A network node for collecting network management information from a plurality of neighboring nodes in a traffic network in response to a network management request received from an originating node, said network node comprising:
means for determining local management information needed to respond to the request;
means for utilizing application-layer knowledge of the functionality of each neighboring node to identify neighboring nodes where the remote management information is located;
means for utilizing a functional management overlay layer to send request messages to the identified neighboring nodes to request the remote management information;
means for receiving the requested remote management information in response messages from the identified neighboring nodes; and
means for aggregating the remote management information and the local management information and sending the aggregated information to the originating node.

17. The network node as recited in claim 16, wherein the network node and at least one of the identified neighboring nodes are co-located in a single physical node.
